(19) United States
(12) Patent Application Publication
(10) Pub. No.: US 2008/0298924 A1
(43) Pub. Date: Dec. 4, 2008

(54) Riveting structure

(75) Inventor: Han-Chung Ho, Chung-Ho City (TW)

Correspondence Address: RABIN & Berdo, PC, 1101 14TH STREET, NW, SUITE 500, WASHINGTON, DC, 20005, US

(73) Assignee: Cooler Master Co., Ltd.

(21) Appl. No.: 11/802,978

(22) Filed: May 29, 2007

(51) Int. Cl. F16B 13/04

(52) U.S. Cl. 411/43

(57) ABSTRACT

A riveting structure is provided, which includes a rivet and a riveted member. A riveting portion is formed at one end of the rivet, and the riveted member has a blind hole formed thereon for accommodating the riveting portion of the rivet. A deformable pressing portion is formed by extending from the edge of the blind hole, for covering and pressing the riveting portion, so as to securely fix the rivet onto the riveted member

### BACKGROUND OF THE INVENTION

1. Field of Invention

The present invention relates to a riveting structure, and more particularly to a riveting structure in which a rivet is fixed into a blind hole.

2. Related Art

In the current industry, two workpieces are usually joined through various mechanical jointing means, such as screwing, welding, and riveting.

For example, with regard to a riveting structure in the prior art, a riveting structure generally includes a riveted member and at least one rivet fixed to and protruding from the riveted member. The riveted member has a through hole corresponding to the rivet, for the rivet to pass through. The rivet has a rivet head which has a diameter larger than that of the through hole. When the rivet passes through the through hole and protrudes from one side surface of the riveted member, the rivet head rests on another side surface of the riveted member. An external force is applied on the rivet head to deform the riveted member, so as to make the rivet head embedded in the riveted member, such that the rivet can be fixed on the riveted member. The part of the rivet protruding from the riveted member may be further joined with a workpiece to be jointed to the riveted member, so as to fix the workpiece on the riveted member.

The rivet head is forced to be embedded in the riveted member to fix the rivet on the riveted member. However, only one side of the rivet head rests on the riveted member, while the other side is exposed out of the side surface of the riveted member and is not constrained at all. Therefore, regarding to the longitudinal direction of the rivet, the rivet head can only provide fixing force in only one direction. That is, the rivet can bear an external force exerted on the rivet head toward the riveted member, but cannot bear a reverse force to draw out the rivet from the riveted member, i.e., an external force applied on the tip of the rivet, which causes an unsatisfying fixing effect for the rivet on the riveted member. As a result, when the tip of the rivet is impacted by an external force to draw out the rivet, the rivet withstands the external force only depending on a tight fit effect between the rivet and the riveted member, with a result that the rivet is most likely drawn out from the riveted member.

Furthermore, when the rivet wobbles under the impact of a radial external force, the rivet and the riveted member may be worn due to the repeated contact and friction caused by wobbling, with a result that the diameter of the rivet becomes smaller than the original one and the rivet may be slightly deformed. Meanwhile, the diameter of the through hole becomes larger than the original one and the through hole is deformed as the riveted member is pulled and dragged to be deformed or worn by the rivet. Consequently, the tight fit effect between the rivet and the riveted member disappears, and the rivet becomes loose and may drop from the riveted member.

On the other hand, since the rivet head has be embedded into the riveted member, the rivet cannot be successfully embedded into the riveted member unless the material strength of the rivet is larger than that of the riveted member. Therefore, in order to satisfy the requirements of the material of the rivet, it is restricted in selecting the material for manufacturing the riveted member, thus causing an increase in the manufacturing cost.

Furthermore, although the rivet head is forced to be embedded into the surface of the riveted member, a part of the rivet head still protrudes from the surface of the riveted member, thus affecting the whole appearance of the product. In order to solve the defect in the appearance caused by the rivet, a process must be further added to remove off the part of the rivet head protrudes from the surface of the riveted member. As such, the manufacturing cost is further increased and the production efficiency is also degraded due to the additional process.

### SUMMARY OF THE INVENTION

In view of the aforementioned problems, the object of the present invention is to provide a riveting structure to solve the problems in the prior art that the rivet easily gets loose and may even drop off under the impact of an external force, the materials of the rivet and the riveted member are restricted, and the process becomes too complicated in consideration of the appearance.

To achieve the object afore mentioned, a riveting structure of the present invention is provided, which includes a rivet and a riveted member. The rivet has a riveting portion formed at one end of the rivet, and the riveted member has a blind hole formed thereon for accommodating the riveting portion In the blind hole A deformable pressing portion is formed by extending from an edge of the blind hole for covering and pressing the riveting portion, so as to securely fix the rivet on the riveted member.

The advantages of the present invention are as follows. The deformable pressing portion formed by extending from the edge of the blind hole is deformed to press and cover the riveting portion of the rivet in the blind hole, since the riveting portion is completely pressed and covered by the deformable pressing portion, the rivet is securely fixed to the riveted member to withstand external forces exerted on the rivet in any direction. Thereby, the present invention solves the problems in the prior art that the rivet easily drops off under the impact of an external force, the materials of the rivet and the riveted member are limited, or the process becomes too complicated in order to improve the surface flatness and the appearance of the riveted member.

The features and practice of the preferred embodiments of the present invention will be illustrated in detail below with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an exploded perspective view of the present invention;

FIG. 2A is a schematic perspective view of the present invention not in a deformable pressing state;

FIG. 2B is a schematic sectional view of the present invention not in a deformable pressing state;

FIG. 3A is a schematic perspective view of the present invention in a deformable pressing state; and

FIG. 3B is a schematic sectional view of the present invention in a deformable pressing state.

### DETAILED DESCRIPTION OF THE INVENTION

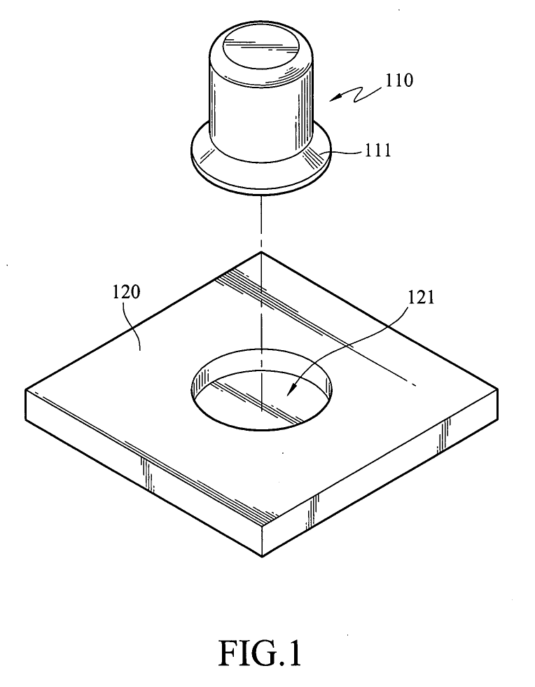

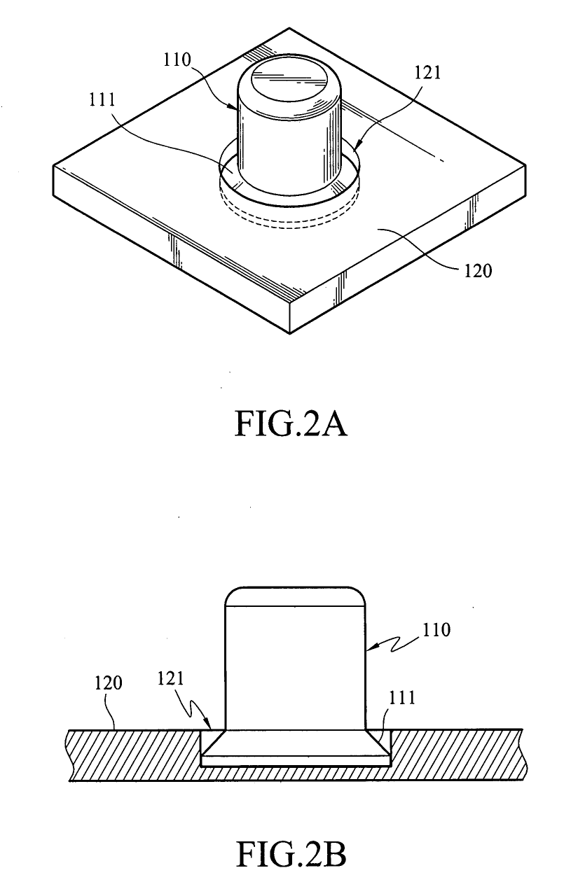

Referring to FIGS. 1, 2A, and 2B, a riveting structure in an embodiment of the present invention is provided, wherein the riveting structure includes a rivet 110 and a riveted member 120. The rivet 110 is fixed to the riveted member 120, so as to be jointed with a workpiece to be fixed on the riveted member 120.

Referring to FIGS. 1, 2A, and 2B, the rivet 110 has a riveting portion 111 formed at one end of the rivet 110. The riveting portion 111 is a flange formed on the periphery of the rivet 110. The riveting portion 111 extends outward along the radial direction of the rivet 110, such that the diameter of the riveting portion 111 is larger than that of the main body of the rivet 110. Moreover, the riveting portion 111 further has an inclined surface formed at one side of the riveting portion 111 and facing the other end of the rivet 110.

Referring to FIGS. 1, 2A, and 2B, the riveted member 120 has a blind hole 121 formed on a side surface of the riveted member 120 for accommodating the riveting portion 111 of the rivet 110 in the blind hole 121, so as to fix the rivet 110 to the riveted member 120.

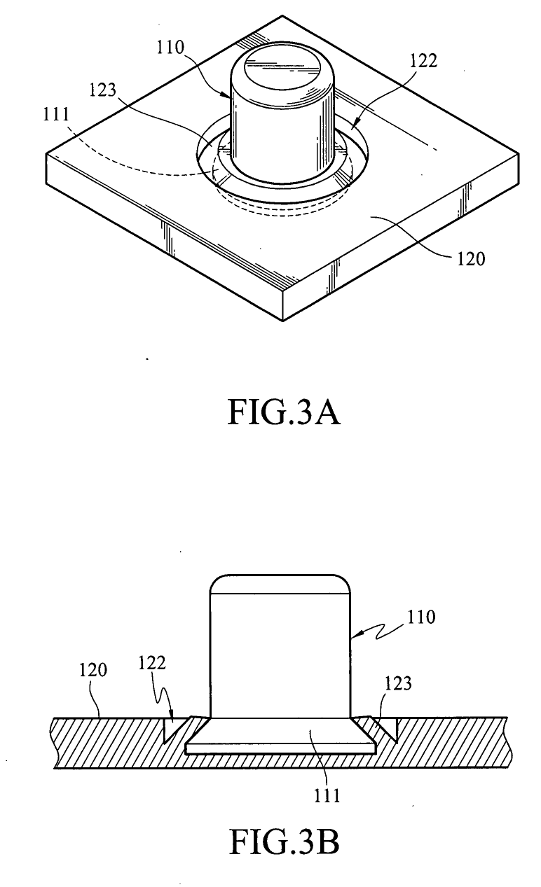

Referring to FIGS. 3A and 3B, the part of riveted member 120 around the blind hole 121 is punched to be deformed by a pinching tool (not shown), such that a deformable pressing portion is formed by extending from the edge of the riveted member, wherein the deformable pressing portion 123 is formed for pressing and covering the riveting portion 111 of the rivet 110. Generally, an annular groove 122 is formed on the riveted member 120 to be around the blind hole 121 through the punching process of the punching tool, wherein the groove 122 spaced from the edge of the blind hole 121, so as to form the deformable pressing portion 123 between the blind hole 121 and the groove 122. When the punching tool for the punching process is continuously moved downward, the deformable pressing portion 123 is deformed and bent to the blind hole 121, and finally the deformable pressing portion 123 is deformed to press and cover the riveting portion 111, so as to securely fix the rivet 110 to the riveted member 120.

Furthermore, in order to make the deformable pressing portion 123 press and cover the riveting portion 111 closely, an angle is formed between the inclined surface of the riveting portion 111 and the radial direction of the rivet 110, such that the rivet 110 is securely fixed to the riveted member 120. Therefore, the rivet 110 would not drop off from the riveted member 120 due to the impact of an external force, and the inclined surface of the riveting portion 111 further makes small deformation of the deformable pressing portion 123, thus maintaining the complete appearance and surface flatness of the riveted member 120.

Compared with the prior art, the blind hole is formed on the riveted member of the present invention, so as to accommodate the riveting portion of the rivet. Moreover, the deformable pressing portion is f formed by extending from an edge of the blind hole for covering and pressing the riveting portion, so as to enhance the fixing force for fixing the rivet to the riveted member, efficiently withstand external force exerted on the rivet in any direction, and efficiently solve the problem that the rivet is easily to be drawn out and even drop from the riveted member by the impact of the external forces. Further, it is unnecessary to restrict the material of the riveted member in consideration of the material strength of the rivet. The riveting structure of the present invention also has favorable overall flatness and appearance, and no additional process is needed to remove the exposed riveting portion. As such, not only the purpose of securely fixing the rivet is achieved, but also the manufacturing cost is significantly reduced, and the production efficiency is also significantly enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A riveting structure, comprising:
a rivet, having a riveting portion formed at one end of the rivet; and
a riveted member, having a blind hole formed thereon for accommodating the riveting portion in the blind hole, wherein a deformable pressing portion is formed by extending from an edge of the blind hole for covering and pressing the riveting portion.

2. The riveting structure as claimed in claim 1, wherein a groove formed on the riveted member and spaced from the edge of the blind hole.

3. The riveting structure as claimed in claim 2, wherein the groove is annular to be formed around the blind hole.

4. The riveting structure as claimed in claim 1, wherein the riveting portion is a flange, formed around a periphery of the rivet and extending outward along a radial direction of the rivet.

5. The riveting structure as claimed in claim 4, wherein the riveting portion further has an inclined surface, formed at one side of the riveting portion and facing the other end of the rivet, an angle is formed between the inclined surface and the radial direction of the rivet, and the deformable pressing portion formed and extending from the edge of the blind hole presses and covers on the inclined surface.
